(19) United States
(12) Patent Application Publication
(10) Pub. No.: US 2002/0022583 A1
(43) Pub. Date: Feb. 21, 2002

(54) Liquid detergent compositions

(75) Inventors: Francesco de Buzzaccarini, Breendonk (BE); Etienne Maria Betty Andre Jeuniaux, Merchtem (BE); Jan Julien Marie-Louise Billiauw, Gent (BE); Karel Jozef Maria Depoot, Waregem (BE)

Correspondence Address: THE PROCTER & GAMBLE COMPANY, PATENT DIVISION, IVORYDALE TECHNICAL CENTER - BOX 474, 5299 SPRING GROVE AVENUE, CINCINNATI, OH, 45217, US

(73) Assignee: The Procter & Gamble Company

(21) Appl. No.: 09/850,571

(22) Filed: May 7, 2001

(30) Foreign Application Priority Data
May 5, 2000 (GB) 0010792.0

(51) Int. Cl. C11D 17/00; C11D 7/02; C11D 3/00

(52) U.S. Cl. 510/424; 510/425; 510/426; 510/507; 510/515

(57) ABSTRACT

The present invention relates to liquid detergent compositions which comprise at least 4.5% of softening clay(s) and a surfactant system of anionic sulphate and/or sulfonate surfactants, preferably only sodium salts thereof, and optionally cationic surfactants, which comprises only very low levels, but is preferably free of alkoxylated anionic and/or non-ionic surfactants. The compositions provide improved fabric softening and deliver improved cleaning.

### CROSS REFERENCE TO RELATED APPLICATIONS

This application claims priority under 37 U.S.C. § 119(a) to Great Britain Application Ser. No. 0010792.0, filed May 5, 2000 (Attorney Docket No. CM2346F).

### TECHNICAL FIELD

The present invention relates to liquid detergent compositions, which comprise a fabric softening clay and a surfactant system mainly comprising anionic sulphate and sulfonate surfactants.

### BACKGROUND TO THE INVENTION

Detergent compositions which comprise a softening clay have been known for several years to provide good cleaning as well as softening. However, there is a desire to further improve the softening of such known detergent products.

Various additional or alternative agents to fabric softening clays have been exploited in the art. For example, it has been known to use various non-ionic surfactants, betaine surfactants, fatty acids or silicone-based compounds to provide (additional) softness to fabrics.

Surprisingly, the inventors have now found that in liquid detergent compositions with fabric softening clays, the presence of alkoxylated surfactants, including non-ionic alkoxylated surfactants, has a negative impact on the softening performance of the fabric softening clays. This is in clear contrast to the general understanding in the field that alkoxylated surfactant, such as non-ionic ethoxylated aliphatic alcohols, provide additional softness. The inventors surprisingly found that liquid detergents with one or more fabric softening clays and a surfactant system mainly comprising anionic sulphate and/or sulfonate surfactants, but being about free of alkoxylated surfactants, provides a very much improved fabric softening and moreover an improved cleaning performance. Thus, with this simple, optimised system liquid detergent surprisingly improved softening and cleaning is obtained.

Moreover, the inventors found that improved cleaning and processing of liquids with high levels of clay is obtained, when using preferred anionic surfactant systems comprising highly branched alkyl sulphate surfactant or even consisting of such surfactant.

### SUMMARY OF THE INVENTION

The invention relates to a detergent composition comprising at least 4.5% of a fabric softening clay and at least 8% by weight of a surfactant system, preferably at least 15% by weight or even at least 18% by weight, said system comprising:

a) 80% to 100% of a salt of a sulfonate surfactant and/or a salt of sulphate surfactant;

b) less then 10% by weight of alkoxylated anionic surfactants, alkoxylated amphoteric surfactants, alkoxylated zwitterionic surfactants and/or alkoxylated non-ionic surfactant;

c) optionally up to 20% of cationic surfactant, zwitterionic surfactant and/or amphoteric surfactant.

If any alkoxylated nonionic surfactant is present, this should not be more than 10% by weight of the surfactant system and 1.5% of the total formulation and preferably, this should then only be alkoxylated non-ionic surfactant having an average alkoxylation degree of 6 or below.

Preferably, the composition comprises a surfactant system, which contains only sodium salts of alkyl sulphate and/or sodium salts of alkyl benzene sulfonate surfactans and optionally cationic surfactant, but no alkoxylated anionic, non-ionic, amphteric or zwitterionic surfactants.

Highly preferred may be that the sulphate surfactant comprises or consists of highly branched alkyl sulphate surfactant(s), such that the weight average branching degree of the total of alkyl sulphate surfactants is at least 50%, preferably at least 60% or even at least 80%, or even at least 90%. Preferred may be that only one type of commercially available branched alkyl sulphate surfactant is present, whereby the weight average branching degree is at least 50%, preferably at least 60% or even at least 80%, or even at least 90%.

The liquid compositions are preferably free of any alkoxylated anionic or non-ionic surfactants.

Preferred is also that the composition is free of any alkanolamines having in total only 1 to 6 carbon atoms.

Preferred is also that the composition comprises at least two types of softening clays.

### DETAILED DESCRIPTION

The compositions of the invention are liquid compositions, preferably they are concentrated liquids having preferably less than 70% or even less than 60% by weight of solvent, preferably less than 50% or even less than 40% or even less than 35% by weight. Preferably, the solvent comprises less than 10% by weight or even less than 5% or even less than 3% by weight of an alcohol, such as ethonol. Therefore, the solvent preferably mainly comprising water and only very low levels of alcohol.

The compositions can be used in automatic washing or hand washing. Also, the compositions can be such that they are suitable for pre-treatment or soaking, or for conditioning of the fabric after the main wash.

The liquid composition preferably has a viscosity of 500 to 3000 cps (centipoises), as measured at a rate of 20 s⁻¹, more preferably from 500 to 2000 cps or even from 800 to 1600 cps.

The liquid composition preferably has a density of 0.8 kg/l to 1.3 kg/l, preferably around 1.0 to 1.1 kg/l.

The liquid composition comprises preferably a colorant or dye and/or pearlescence agent.

The compositions of the invention contain one or more fabric softening clays, present at a level of at least 4.5% by weight, preferably at least 5.5% o even 6.5% or even at least 7% by weight.

Preferred fabric softening clays are smectite clays, which can also be used to prepare the organophilic clays described hereinafter, for example as disclosed in EP-A-299575 and EP-A-313146. Specific examples of suitable smectite clays are selected from the classes of the bentonites—also known as montmorillonites, hectorites, volchonskoites, nontronites, saponites and sauconites, particularly those having an alkali or alkaline earth metal ion within the crystal lattice structure.

Preferably, hectorites or montmorillonites or mixtures thereof.

Hectorites are most preferred clays, preferably present at levels up to 12%, more preferably up to 10% or even up to 8% by weight.

Quite suitable are hectorites of natural origin, in the form of particles having the general formula:

[(Mg₃₋ₓLiₓ)Si_{4-y}Me_{y}O₁₀(OH_{2-z}F_{z})]^{-(x+y)}(x+y)Mⁿ⁺ III

wherein Me^{III} is Al, Fe, or B; or y=o; Mⁿ⁺ is a monovalent (n=1) or divalent (n=2) metal ion, for example selected from Na, K, Mg, Ca, Sr. In the above formula, the value of (x+y) is the layer charge of the hectorite clay. Such hectorite clays are preferably selected on the basis of their layer charge properties, i.e. at least 50% is in the range of from 0.23 to 0.31. More suitable are hectorite clays of natural origin having a layer charge distribution such that at least 65% is in the range of from 0.23 to 0.31.

The hectorite clays suitable in the present composition should preferably be sodium clays, for better softening activity.

Sodium clays are either naturally occurring, or are naturally-occuring calcium-clays which have been treated so as to convert them to sodium-clays. If calcium-clays are used in the present compositions, a salt of sodium can be added to the compositions in order to convert the calcium clay to a sodium clay. Preferably, such a salt is sodium carbonate, typically added at levels of up to 5% of the total amount of clay.

Examples of hectorite clays suitable for the present compositions include Bentone EW as sold by Elementis.

Another preferred clay is an organophilic clay, preferably a smectite clay, whereby at least 30% or even at least 40% or preferably at least 50% or even at least 60% of the exchangeable cations is replaced by a, preferably long-chain, organic cations. Such clays are also referred to as hydrophobic clays. The cation exchange capacity of clays and the percentage of exchange of the cations with the long-chain organic cations can be measured in several ways known in the art, as for example fully set out in Grimshaw, The Chemistry and Physics of Clays, Interscience Publishers, Inc.,pp. 264-265 (1971).

Whilst the organophilic smectite clay provides excellent softening benefit, they can increase the viscosity of the liquid compositions. Therefore, it will depend on the viscosity requirements of the composition, how much of these organophlic clays can be used. Typically, they are used in the liquid detergent compositions of the invention at a level of from 0.1% to 10%, more preferably from 0.3% to 7%, most preferably from 0.4% to 5% or even 0.5% to 4% by weight of the composition.

These organophilic clays are formed prior to incorporation into the detergent composition. Thus for example, the cations, or part thereof, of the normal smectite clays are replaced by the long-chain organic cations to form the organophilic smectite clays herein, prior to further processing of the material to form the detergents of the invention.

The organophilic clay is preferably in the form of a platelet or lath-shaped particle. Preferably the ratio of the width to the length of such a platelet is at least 1:2, preferably at least 1:4 or even at least 1:6 or even at least 1:8.

When used herein, a long-chain organic cation can be any compound which comprises at least one chain having at least 6 carbon atoms, but typically at least 10 carbon atoms, preferably at least 12 carbon atoms, or in certain embodiments of the invention, at least 16 or even at least 18 carbon atoms. Preferred long-chain organic cations are described hereinafter.

Preferred organophilic clays herein clay are smectite clays, preferably hectorite clays and/or montmorillonite clays containing one or more organic cations of formulae:

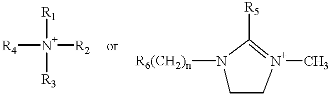

where R₁ represents an organic radical selected from R₇, R₇—CO—O—(CH₂)ₙ, or

R₇—CO—NR₈— in which R₇ is an alkyl, alkenyl or alkylaryl group with 12-22 carbon atoms, whereby R₈ is hydrogen, C₁-C₄ alkyl, alkenyl or hydroxyalkyl, preferably —CH₃ or —C₂H₅ or —H; n is an integer, preferably equal to 2 or 3; R₂ represents an organic radical selected from R₁ or C₁-C₄ alkyl, alkenyl or hydroxyalkyl, preferably —CH₃ or —CH₂CH₂OH; R₃ and R₄ are organic radicals selected from C₁-C₄ alkyl-aryl, C₁-C₄ alkyl, alkenyl or hydroxyalkyl, preferably —CH₃, —CH₂CH₂OH, or benzyl group; R₅ is an alkyl or alkenyl group with 12-22 carbon atoms; R₆ is preferably —OH, —NHCO—R₇, or —OCO—R₇.

Highly preferred cations are quaternary ammonium cations having two C₁₆-C₂₈ or even C₁₆-C₂₄ alkyl chains. Highly preferred are one or more organic cations which have one or preferably two alkyl groups derived from natural fatty alcohols, the cations preferably being selected from dicocoyl methyl benzyl ammonium, dicocoyl ethyl benzyl ammonium, dicocoyl dimethyl ammonium, dicocoyl diethyl ammonium; more preferably ditallow diethyl ammonium, ditallow ethyl benzyl ammonium; more preferably ditallow dimethyl ammonium and/or ditallow methyl benzyl ammonium.

It may be highly preferred that mixtures of organic cations are present.

Highly preferred are organophilic clays as available from Rheox/Elementis, such as Bentone SD-1 and Bentone SD-3, which are registered trademarks of Rheox/Elementis.

### Anionic Surfactant

The detergent compositions of the invention comprise preferably a surfactant system whereof 80-100% is or are anionic sulphate and/or sulfonate surfactant(s).

The anionic sulphate and/or sulfonate surfactant(s) are preferably present at a level of at least 8% by weight of the composition. More preferably these anionic surfactant is present at a level of from 10% to 40%, more preferably from 15% or even 18% to 30% by weight of the composition. Preferred amounts of the alkyl sulphate surfactant, are from 16% to 40%, or more preferably 18% to 25% by weight of the detergent composition. It may be preferred that only one type of anionic surfactant is present, for example in may be preferred that only alkyl sulphate surfactant is present as anionic surfactant.

Anionic sulfonate surfactants suitable for use herein include the salts of a C₅-C₂₀, more preferably a C₁₀-C₁₆, more preferably a C₁₁-C₁₃ alkylbenzene sulfonates, alkyl ester sulfonates, C₆-C₂₂ primary or secondary alkane sulfonates, sulfonated polycarboxylic acids, and any mixtures thereof, but preferably C₁₁-C₁₃ alkylbenzene sulfonates.

Anionic sulphate surfactants suitable for use in the compositions or components of the invention include the primary and secondary alkyl sulphates, having a linear or branched alkyl or alkenyl moiety having from 9 to 22 carbon atoms or more preferably C₁₂ to C₁₈ alkyl.

Highly preferred are beta-branched alkyl sulphate surfactants or mixtures of commercial available materials, having a weight average (of the surfactant or the mixture) branching degree of at least 50% or even at least 60% or even at least 80% or even at least 95%. It has been found that these branched sulphate surfactants provide a much better viscosity profile, when clays are present, particular when 5% or more clay is present.

It may be preferred that the only sulphate surfactant is such a highly branched alkyl sulphate surfactant, namely referred may be that only one type of commercially available branched alkyl sulphate surfactant is present, whereby the weight average branching degree is at least 50%, preferably at least 60% or even at least 80%, or even at least 90%. Preferred is for example Isalchem, as available form Condea.

It may also be preferred that this is the only anionic surfactant present.

Mid-chain branched alkyl sulphates or sulfonates are also suitable anionic surfactants for use in the compositions of the invention. Preferred are the mid-chain branched alkyl sulphates. Preferred mid-chain branched primary alkyl sulphate surfactants are of the formula

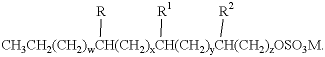

These surfactants have a linear primary alkyl sulphate chain backbone (i.e., the longest linear carbon chain which includes the sulphated carbon atom), which preferably comprises from 12 to 19 carbon atoms and their branched primary alkyl moieties comprise preferably a total of at least 14 and preferably no more than 20, carbon atoms. In compositions or components thereof of the invention comprising more than one of these sulphate surfactants, the average total number of carbon atoms for the branched primary alkyl moieties is preferably within the range of from greater than 14.5 to about 17.5. Thus, the surfactant system preferably comprises at least one branched primary alkyl sulphate surfactant compound having a longest linear carbon chain of not less than 12 carbon atoms or not more than 19 carbon atoms, and the total number of carbon atoms including branching must be at least 14, and further the average total number of carbon atoms for the branched primary alkyl moiety is within the range of greater than 14.5 to about 17.5.

Preferred mono-methyl branched primary alkyl sulphates are selected from the group consisting of: 3-methyl pentadecanol sulphate, 4-methyl pentadecanol sulphate, 5-methyl pentadecanol sulphate, 6-methyl pentadecanol sulphate, 7-methyl pentadecanol sulphate, 8-methyl pentadecanol sulphate, 9-methyl pentadecanol sulphate, 10-methyl pentadecanol sulphate, 11-methyl pentadecanol sulphate, 12- methyl pentadecanol sulphate, 13- methyl pentadecanol sulphate, 3-methyl hexadecanol sulphate, 4-methyl hexadecanol sulphate, 5-methyl hexadecanol sulphate, 6-methyl hexadecanol sulphate, 7-methyl hexadecanol sulphate, 8-methyl hexadecanol sulphate, 9-methyl hexadecanol sulphate, 10-methyl hexadecanol sulphate, 11-methyl hexadecanol sulphate, 12-methyl hexadecanol sulphate, 13-methyl hexadecanol sulphate, 14-methyl hexadecanol sulphate, and mixtures thereof.

Preferred di-methyl branched primary alkyl sulphates are selected from the group consisting of: 2,3-methyl tetradecanol sulphate, 2,4-methyl tetradecanol sulphate, 2,5-methyl tetradecanol sulphate, 2,6-methyl tetradecanol sulphate, 2,7-methyl tetradecanol sulphate, 2,8-methyl tetradecanol sulphate, 2,9-methyl tetradecanol sulphate, 2,10-methyl tetradecanol sulphate, 2,11-methyl tetradecanol sulphate, 2,12-methyl tetradecanol sulphate, 2,3-methyl pentadecanol sulphate, 2,4-methyl pentadecanol sulphate, 2,5-methyl pentadecanol sulphate, 2,6-methyl pentadecanol sulphate, 2,7-methyl pentadecanol sulphate, 2,8-methyl pentadecanol sulphate, 2,9-methyl pentadecanol sulphate, 2,10-methyl pentadecanol sulphate, 2,11-methyl pentadecanol sulphate, 2,12-methyl pentadecanol sulphate, 2,13-methyl pentadecanol sulphate, and mixtures thereof.

It is preferred that the anionic surfactants herein are present in the form of sodium salts.

### Additional Detergent Actives

The compositions in accord with the invention typically contain additional detergent actives. The compositions of the invention preferably contain one or more additional detergent components selected from alkalinity systems, additional viscosity controlling systems, hydrogen peroxide or sources therefor, builders, enzymes, suds suppressers, lime soap, dispersants, perfumes, brighteners, photo-bleaching agents, corrosion inhibitors, soil release polymers, fabric conditioning agents such as cellulose based polymers, including carboxy methyl cellulose, cellulose ethers or ester, amine or amide modified celluloses, dye transfer inhibitors, and/or process aids. These ingredients are described in more detail herein.

Highly preferred maybe that one or more fatty acids and/or optionally salts thereof (and then preferably sodium salts) are present in the detergent composition. It has been found that this can provide further improved softening and cleaning of the fabrics. Preferably, the compositions contain 1% to 25% by weight of a fatty acid or salt thereof, more preferably 6% to 18% or even 10% to 16% by weight. Preferred are in particular C₁₂-C₁₈ saturated and/or unsaturated fatty acids, but preferably mixtures of such fatty acids. Highly preferred have been found mixtures of saturated and unsaturated fatty acids, for example preferred is a mixture of rape seed-derived fatty acid and C₁₆-C₁₈ topped whole cut fatty acids, or a mixture of rape seed-derived fatty acid and a tallow alcohol derived fatty acid.

Highly preferred are perfume components, preferably at least one component comprising a coating agent and/or carrier material, preferably an encapsulate of for example starch or other cellulosic material. The inventors have found that the perfumes are more efficiently deposited onto the fabric in the compositions of the invention, comprising these clays, in particular when organophlic clays are present.

The compositions of the invention may comprise cationic surfactant compounds (which are preferably not deliberately made in the form of a complex with the clays as described above). Suitable cationic surfactants to be used in the detergent herein include the quaternary ammonium surfactants, which can have up to 26 carbon atoms. Preferably the quaternary ammonium surfactant is a mono C₁₁-C₁₈ N-alkyl or alkenyl ammonium surfactants wherein the remaining N positions are substituted by methyl, hydroxyethyl or hydroxypropyl groups

Preferred are also cationic mono-alkoxylated and bis-alkoxylated quaternary amine surfactants with a C₆-C₁₈ N-alkyl chain, such as of the general formula I:

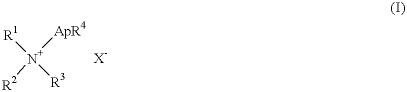

wherein R¹ is an alkyl or alkenyl moiety containing from about 6 to about 18 carbon atoms, preferably 6 to about 16 carbon atoms, most preferably from about 6 to about 14 carbon atoms; R² and R³ are each independently alkyl groups containing from one to about three carbon atoms, preferably methyl, most preferably both R² and R³ are methyl groups; R⁴ is selected from hydrogen (preferred), methyl and ethyl; X⁻ is an anion such as chloride, bromide, methylsulphate, sulphate, or the like, to provide electrical neutrality; A is a alkoxy group, especially a ethoxy, propoxy or butoxy group; and p is from 0 to about 30, preferably 2 to about 15, most preferably 2 to about 8.

The cationic bis-alkoxylated amine surfactant preferably has the general formula II:

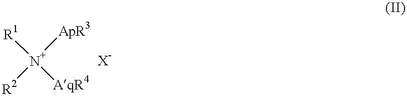

wherein R¹ is an alkyl or alkenyl moiety containing from about 8 to about 18 carbon atoms, preferably 10 to about 16 carbon atoms, most preferably from about 10 to about 14 carbon atoms; R² is an alkyl group containing from one to three carbon atoms, preferably methyl; R³ and R⁴ can vary independently and are selected from hydrogen (preferred), methyl and ethyl, X⁻ is an anion such as chloride, bromide, methylsulphate, sulphate, or the like, sufficient to provide electrical neutrality. A and A″ can vary independently and are each selected from C₁-C₄ alkoxy, especially ethoxy, (i.e., —CH₂CH₂O—), propoxy, butoxy and mixtures thereof; p is from 1 to about 30, preferably 1 to about 4 and q is from 1 to about 30, preferably 1 to about 4, and most preferably both p and q are 1.

Another suitable group of cationic surfactants which can be used in the detergent compositions are cationic ester surfactants. Suitable cationic ester surfactants, including choline ester surfactants, have for example been disclosed in U.S. Pat. Nos. 4,228,042, 4,239,660 and 4,260,529.

The compositions in accord with the present invention preferably contain a water-soluble builder compound, typically present in detergent compositions at a level of from 1% to 60% by weight, preferably from 3% to 40% by weight, most preferably from 5% to 25% by weight of the composition.

Suitable water-soluble builder compounds include the water soluble monomeric carboxylates, or their acid forms, or polycarboxylates or acids thereof homo or copolymeric polycarboxylic acids or their salts in which the polycarboxylic acid comprises at least two carboxylic radicals separated from each other by not more that two carbon atoms, borates, and mixtures of any of the foregoing.

The carboxylate or polycarboxylate builder can be momomeric or oligomeric in type although monomeric polycarboxylates are generally preferred for reasons of cost and performance. The parent acids of the monomeric or oligomeric polycarboxylate chelating agents or mixtures thereof with their salts, e.g. citric acid or citrate/citric acid mixtures are also contemplated as useful builder components.

The monomeric carboxylic acids and salts thereof include the highly preferred fatty acid or salts, as described above.

Also highly preferred are citric acid and/or sodium citrate builders, preferably present at a level of 1% to 20%, more preferably from 3% to 15%, more preferably from 5% to 12% by weight of the composition.

Borate or boric acid builders, as well as builders containing borate-forming materials that can produce borate under detergent storage or wash conditions are useful water-soluble builders herein.

The detergent compositions of the invention may comprise phosphate-containing builder material. Preferably present at a level of from 2% to 40%, more preferably from 3% to 30%, more preferably from 5% to 20%. Suitable examples of water-soluble phosphate builders are the alkali metal tripolyphosphates, sodium, potassium and ammonium pyrophosphate, sodium and potassium and ammonium pyrophosphate, sodium and potassium orthophosphate, sodium polymeta/phosphate in which the degree of polymerization ranges from about 6 to 21, and salts of phytic acid.

The compositions in accord with the present invention may contain a partially soluble or insoluble builder compound, typically present in detergent compositions at a level of from 0.5% to 60% by weight, preferably from 5% to 50% by weight, most preferably from 8% to 40% weight of the composition.

Preferred are aluminosilicates and/or crystalline layered silicates such as SKS-6, available from Clariant.

However, from a formulation point of view it may be preferred not to include such builders in the liquid composition, because it will lead to too much dispersed or precipitate material in the liquid, or it requires too much process or dispersion aids.

The compositions of the invention preferably contain as an optional component a heavy metal ion sequestrant. By heavy metal ion sequestrant it is meant herein components which act to sequester (chelate) heavy metal ions. These components may also have calcium and magnesium chelation capacity, but preferentially they show selectivity to binding heavy metal ions such as iron, manganese and copper.

Heavy metal ion sequestrants are generally present at a level of from 0.005% to 10%, preferably from 0.1% to 5%, more preferably from 0.25% to 7.5% and most preferably from 0.3% to 2% by weight of the compositions.

Suitable heavy metal ion sequestrants for use herein include organic phosphonates, such as the amino alkylene poly (alkylene phosphonates), alkali metal ethane 1-hydroxy disphosphonates and nitrilo trimethylene phosphonates.

Preferred among the above species are diethylene triamine penta (methylene phosphonate), ethylene diamine tri (methylene phosphonate) hexamethylene diamine tetra (methylene phosphonate) and hydroxy-ethylene 1,1 diphosphonate, 1,1 hydroxyethane diphosphonic acid and 1,1 hydroxyethane dimethylene phosphonic acid.

Other suitable heavy metal ion sequestrant for use herein include nitrilotriacetic acid and polyaminocarboxylic acids such as ethylenediaminotetracetic acid, ethylenediamine disuccinic acid, ethylenediamine diglutaric acid, 2-hydroxypropylenediamine disuccinic acid or any salts thereof.

Other suitable heavy metal ion sequestrants for use herein are iminodiacetic acid derivatives such as 2-hydroxyethyl diacetic acid or glyceryl imino diacetic acid, described in EP-A-317,542 and EP-A-399,133. The iminodiacetic acid-N-2-hydroxypropyl sulfonic acid and aspartic acid N-carboxymethyl N-2-hydroxypropyl-3-sulfonic acid sequestrants described in EP-A-516,102 are also suitable herein. The β-alanine-N,N′-diacetic acid, aspartic acid-N,N′-diacetic acid, aspartic acid-N-monoacetic acid and iminodisuccinic acid sequestrants described in EP-A-509,382 are also suitable.

EP-A-476,257 describes suitable amino based sequestrants. EP-A-510,331 describes suitable sequestrants derived from collagen, keratin or casein. EP-A-528,859 describes a suitable alkyl iminodiacetic acid sequestrant. Dipicolinic acid and 2-phosphonobutane-1,2,4-tricarboxylic acid are alos suitable. Glycinamide-N,N′-disuccinic acid (GADS), ethylenediamine-N-N′-diglutaric acid (EDDG) and 2-hydroxypropylenediamine-N-N′-disuccinic acid (HPDDS) are also suitable.

Especially preferred are diethylenetriamine pentacetic acid, ethylenediamine-N,N′-disuccinic acid (EDDS) and 1,1 hydroxyethane diphosphonic acid or the alkali metal, alkaline earth metal, ammonium, or substituted ammonium salts thereof, or mixtures thereof.

Another preferred ingredient useful in the compositions herein is one or more enzymes.

Preferred enzymatic materials include the commercially available lipases, cutinases, amylases, neutral and alkaline proteases, cellulases, endolases, esterases, pectinases, lactases and peroxidases conventionally incorporated into detergent compositions. Suitable enzymes are discussed in U.S. Pat. Nos. 3,519,570 and 3,533,139.

Preferred commercially available protease enzymes include those sold under the tradenames Alcalase, Savinase, Primase, Durazym, and Esperase by Novo Industries A/S (Denmark), those sold under the tradename Maxatase, Maxacal and Maxapem by Gist-Brocades, those sold by Genencor International, and those sold under the tradename Opticlean and Optimase by Solvay Enzymes. Protease enzyme may be incorporated into the compositions in accordance with the invention at a level of from 0.0001% to 4% active enzyme by weight of the composition.

Preferred amylases include, for example, α-amylases obtained from a special strain of B licheniformis, described in more detail in GB-1,269,839 (Novo). Preferred commercially available amylases include for example, those sold under the tradename Rapidase by Gist-Brocades, and those sold under the tradename Termamyl, Duramyl and BAN by Novo Industries A/S. Highly preferred amylase enzymes maybe those described in PCT/US 9703635, and in WO95/26397 and WO96/23873.

Amylase enzyme may be incorporated into the composition in accordance with the invention at a level of from 0.0001% to 2% active enzyme by weight of the composition.

Useful organic polymeric compounds for inclusion in the compositions herein include the water soluble organic homo- or co-polymeric polycarboxylic acids or their salts in which the polycarboxylic acid comprises at least two carboxyl radicals separated from each other by not more than two carbon atoms. Polymers of the latter type are disclosed in GB-A-1,596,756. Examples of such salts are polyacrylates of MWt 1000-5000 and their copolymers with maleic anhydride, such copolymers having a molecular weight of from 2000 to 100,000, especially 40,000 to 80,000.

Other organic polymeric compounds suitable for incorporation in the detergent compositions herein include cellulose derivatives such as methylcellulose, carboxymethylcellulose, hydroxypropylmethylcellulose and hydroxyethylcellulose.

The detergent compositions of the invention, when formulated for use in machine washing compositions, may comprise a suds suppressing system present at a level of from 0.01% to 15%, preferably from 0.02% to 10%, most preferably from 0.05% to 3% by weight of the composition.

Suitable suds suppressing systems for use herein may comprise essentially any known antifoam compound, including for example silicone antifoam compounds and 2-alkyl alcanol antifoam compounds.

Other suitable antifoam compounds include the monocarboxylic fatty acids and soluble salts thereof, as also described as builders above. These materials are described in U.S. Pat. No. 2,954,347, issued Sep. 27, 1960 to Wayne St. John. The monocarboxylic fatty acids, and salts thereof, for use as suds suppressor typically have hydrocarbyl chains of 10 to 24 carbon atoms, preferably 12 to 18 carbon atoms. Suitable salts include the alkali metal salts such as in particular sodium but also potassium salts.

The compositions herein may also comprise from 0.01% to 10%, preferably from 0.05% to 0.5% by weight of polymeric dye transfer inhibiting agents.

The polymeric dye transfer inhibiting agents are preferably selected from polyamine N-oxide polymers, copolymers of N-vinylpyrrolidone and N-vinylimidazole, polyvinylpyrrolidonepolymers or combinations thereof, whereby these polymers can be cross-linked polymers.

The compositions herein also optionally contain from about 0.005% to 5% by weight of certain types of hydrophilic optical brighteners.

Preferred brighteners include 4,4′,-bis[(4-anilino-6-(N-2-bis-hydroxyethyl)-s-triazine-2-yl)amino]-2,2′-stilbenedisulfonic acid and disodium salt, commercially marketed under the tradename Tinopal-UNPA-GX by Ciba-Geigy Corporation; 4,4′-bis[(4-anilino-6-(N-2-hydroxyethyl-N-methylamino)-s-triazine-2-yl)amino]2,2′-stilbenedisulfonic acid disodium salt, commercially marketed under the tradename Tinopal 5BM-GX by Ciba-Geigy Corporation; 4,4′-bis[(4-anilino-6-morphilino-s-triazine-2-yl)amino]2,2′-stilbenedisulfonic acid, sodium salt, commercially marketed under the tradename Tinopal-DMS-X and Tinopal AMS-GX by Ciba Geigy Corporation.

Also preferred may be neutralizing agents, buffering agents, phase regulants, hydrotropes, enzyme stabilizing agents, opacifiers, anti-oxidants, bactericides, photo-bleaches.

### ABBREVIATIONS USED IN EXAMPLES

In the detergent compositions, the abbreviated component identifications have the following meanings:

| | |
|---|---|
| LAS: | Sodium linear C₁₁₋₁₃ alkyl benzene sulfonate |
| TAS: | Sodium tallow alkyl sulphate |
| CxyAS: | Sodium C₁ₓ-C_{1y} alkyl sulphate |
| CxyASz: | Sodium C₁ₓ-C_{1y} alkyl sulphate, having a weight |
| | average branching degree of at least z |
| QAS: | R₂.N⁺(CH₃)₂(C₂H₄OH) with R₂ = C₁₂-C₁₄ |
| QAS 1: | R₂.N⁺(CH₃)₂(C₂H₄OH) with R₂ = C₈-C₁₁ |
| MBAS: | Branched C16-C18 alkylsulphate having an average methyl |
| | branching of 1.5 |
| APA: | C₈-C₁₀ amido propyl dimethyl amine |
| Soap: | Sodium linear alkyl carboxylate derived from an 80/20 mixture |
| | of tallow and coconut fatty acids |
| TPKFA: | C₁₆-C₁₈ topped whole cut fatty acids |
| Citric acid: | Anhydrous citric acid |
| Borate: | Sodium borate |
| Mg sulphate: | Anhydrous magnesium sulphate |
| Citrate: | Tri-sodium citrate dihydrate of activity 86.4% with a particle |
| | size distribution between 425 μm and 850 μm |
| MA/AA: | Copolymer of 1:4 maleic/acrylic acid, average molecular weight |
| | about 70,000 |
| Cellulose ether: | Methyl cellulose ether with a degree of polymerization of 650 |
| | available from Shin Etsu Chemicals |
| Protease: | Proteolytic enzyme, having 3.3% by weight of active enzyme, |
| | sold by NOVO Industries A/S under the tradename Savinase |
| Cellulase: | Cellulytic enzyme, having 0.23% by weight of active enzyme, |
| | sold by NOVO Industries A/S under the tradename Carezyme |
| Amylase: | Amylolytic enzyme, having 1.6% by weight of active enzyme, |
| | sold by NOVO Industries A/S under the tradename Termamyl |
| | 120T |
| Lipase: | Lipolytic enzyme, having 2.0% by weight of active enzyme, |
| | sold by NOVO Industries A/S under the tradename Lipolase or |
| | Lipolase Ultra |
| : | Sodium percarbonate of nominal formula 2Na₂CO₃.3H₂O₂ |
| EDDS: | Ethylenediamine-N,N′-disuccinic acid, (S,S) isomer in the form |
| | of its sodium salt. |
| HEDP: | 1,1-hydroxyethane diphosphonic acid |
| Photoactivated bleach: | Sulfonated zinc phthlocyanine encapsulated in dextrin soluble |
| | polymer |
| Brightener: | Disodium 4,4′-bis(2-sulphostyryl)biphenyl or |
| | Disodium 4,4-bis(4-anilino-6-morpholino-1,3,5-triazin-2- |
| | yl)amino) stilbene-2:2′-disulfonate |
| PVNO: | Polyvinylpyridine N-oxide polymer, with an average molecular |
| | weight of 50,000 |
| PVPVI: | Copolymer of polyvinylpyrolidone and vinylimidazole, with an |
| | average molecular weight of 20,000 |
| Clay I: | Bentone SD-1, as available from Rheox/Elementis |
| Clay II: | Bentone SD-3, as available from Rheox/Elementis |
| Clay III: | Bentone EW, as available from Rheox/Elementis |
| Clay IV: | Montmorillonite clay |
| Opacifier | |

In the following examples all levels are quoted as % by weight of the composition:

### Example 1

The following liquid composition is in accord with the invention:

| Component | A | B | C |
|---|---|---|---|
| C₂₃AS90 and/ or C25AS60 | 14.0 | 20.0 | 5.0 |
| LAS | 6.0 | — | 9.0 |
| Citric Acid | 2.0 | 1.5 | 3.0 |
| C₁₂₋₁₈ Fatty Acid (s) | 16.0 | 12.0 | 18.0 |
| Enzymes | 1.3 | 1.0 | 0.5 |
| QAS | 1.0 | 1.0 | — |
| Propanediol | 2.3 | — | — |
| Boric acid | 2.0 | 2.0 | — |
| Dispersant | 1.4 | — | 1.0 |
| HEDP or EDDS | 0.5 | 0.25 | 1.25 |
| Clay I | 1.0 | 0.5 | 0.5 |
| Clay III | 4.0 | 6.5 | 4.0 |
| Clay IV | — | — | 4.0 |
| Dye, Perfume, Brighteners, Preservatives, | Balance | Balance | Balance |
| Suds Suppressor, Other Minors, water | | | |
| | 100% | 100% | 100% |

### Example 2

The following liquid detergent formulations are prepared according to the present invention

| | A | B | C | D | E |
|---|---|---|---|---|---|
| LAS | 17.5 | 9.0 | — | 4.0 | — |
| C25AS and/or | — | 12.0 | 18.0 | 10.0 | — |
| C25AS80 | | | | | |
| MBAS | — | — | — | 4.0 | 16.0 |
| QAS | — | — | 1.0 | 1.0 | 1.0 |
| Rape seed oil | 7.5 | 3.5 | 14.0 | — | 4.0 |
| fatty acid | | | | | |
| CFAA | 4.0 | — | — | — | 3.0 |
| TPKFA | — | 7.5 | 2.0 | 9.5 | 2.0 |
| Citric acid | 6.5 | 1.0 | 2.5 | 4.0 | 2.5 |
| encapsulated perfume | 0.1 | 1.0 | 2.0 | — | — |
| Na formate or acetate | 0.5 | — | — | 0.5 | — |
| STS | — | 1.0 | — | 1.2 | — |
| Borate/boric acid | 0.6 | 2.0 | 3.0 | 2.0 | 3.0 |
| Na hydroxide | 1.0 | 2.0 | — | 1.0 | 3.0 |
| Ethanol | 2.0 | 1.0 | — | — | 3.0 |
| 1,2 Propanediol | 3.0 | 2.0 | — | — | 5.0 |
| ClayI I | 0.5 | 1.5 | 1.0 | 0.5 | 1.0 |
| Clay III | 7.0 | 4.0 | 6.5 | 8.0 | 5.5 |
| Clay IV | — | 1.0 | 2.0 | — | 1.0 |
| Protease | — | 0.3 | 1.0 | 0.5 | 0.5 |
| Lipase | — | — | 0.2 | — | — |
| Amylase | — | — | — | 0.2 | 0.7 |
| Cellulase | — | — | 0.2 | 0.5 | — |
| PVNO | — | — | 0.3 | — | 0.2 |
| Brightener 1 | 0.2 | 0.07 | 0.1 | — | — |
| Water | | | | | |
| balance: | | | | | |

### Example 3

The following liquid detergent formulations are according to the present invention

| | A | B | C | D | E | F | G | H |
|---|---|---|---|---|---|---|---|---|
| LAS | 10.0 | 80 | 9.0 | — | 25.0 | — | — | 5.0 |
| C25AS60 | 4.0 | 30 | 11. | 8.0 | — | 13.0 | 18.0 | 100 |
| C25A90 | 60 | 3.0 | — | 4. | — | 6. | — | 4.0 |
| C25AS | | 8.0 | — | 8.0 | — | — | — | — |
| rape seed oil | 3.5 | 3.0 | — | 4.5 | 3.0 | 4.0 | 8.0 | |
| fatty acid | | | | | | | | |
| APA | — | 1.4 | — | — | — | 1.0 | — | — |
| TPKFA | 2. | — | 13.0 | 7.0 | 14.0 | 15.0 | — | 11.0 |
| Citric | 2.0 | 3.0 | 1.0 | 1.5 | 1.0 | 1.0 | 1.0 | 1.0 |
| Dodecenyl/ | 4.0 | | — | — | — | — | — | — |
| tetradecenyl | | | | | | | | |
| succinic acid | | | | | | | | |
| Ethanol | 4.0 | | | 2.0 | | 2.0 | | |
| 1,2 Propanediol | | 4.0 | 2.0 | | 6.0 | | | 3.0 |
| Monoethanolamine | — | — | — | 5.0 | — | — | | |
| CMC | 0.2 | | 0.5 | 0.7 | 2.0 | 1.2 | | 4.0 |
| Clay I and III | 6.0 | 5.5 | 7.5 | 9.0 | 5.0 | 8.5 | 13.0 | 6.0 |
| DETPMP | 1.0 | 1.0 | 0.5 | 1.0 | | | | |
| Protease | 0.2 | 1.0 | 0.9 | 0.6 | — | 0.5 | — | 1.2 |
| Lipase | — | | — | | | 0.3 | 0.3 | 0.1 |
| Amylase | 0.4 | 0. | 0.3 | 0.5 | — | — | 0.4 | 0.3 |
| Cellulase | — | — | — | — | — | — | 0.2 | 0.2 |
| Boric acid | 0.1 | 0.2 | 1.0 | 2.0 | 4.0 | 4.0 | — | — |
| Ca chloride | — | 0.02 | — | 0.01 | 0.1 | 0.2 | 0.3 | — |
| Brightener 1 | — | 0.4 | — | — | 0.4 | — | — | — |
| Suds suppressor | | 0.3 | — | 0.1 | 0.8 | 0.7 | — | — |
| Opacifier | 0.5 | 0.4 | — | 0.3 | 8.0 | 7.5 | 8.0 | 8.2 |
| NaOH up to pH | 8.0 | 8.0 | | | | | | |
| 8 | | | | | | | | |
| water up to | | | | | | | | |
| balance | | | | | | | | |

### Example 4

The following liquid composition is in accord with the invention

| | A | B | C | D | E |
|---|---|---|---|---|---|
| LAS | — | 5 | 9 | 14 | — |
| C23AS | 19 | 16 | — | 7.5 | — |
| MBAS | — | — | 5.5 | — | 18.5 |
| QAS | 0.75 | — | 2.0 | — | 2.5 |
| APA | — | — | — | 1.8 | — |
| AES | — | 1.0 | 0.75 | — | — |
| TPKIFA | 10 | 11 | 7.5 | 3.4 | 5.5 |
| RPSFA | 6.5 | 3.5 | 7.5 | 8.2 | — |
| Citric acid | 1.5 | 2.0 | 0.6 | 2.3 | 0.65 |
| DTPMP | 1.1 | 0.7 | 0.8 | — | 0.3 |
| HEDP | 0.4 | — | 0.3 | 0.5 | 0.4 |
| Clay IV | 7.0 | 3.3 | — | 13.5 | 5.7 |
| Clay I | 0.3 | 0.5 | — | — | 1.2 |
| Clay III | — | 3.3 | 6.5 | — | 1.9 |
| Protease/ | 0.85 | 1.1 | 0.7 | — | 1.3 |
| Amylase | | | | | |
| Boric acid | 2.0 | 2.5 | 1.5 | — | 1.9 |
| Ethanol | 3.3 | 3.5 | 4.5 | 5.5 | 2.3 |
| 1,2Propandiol | 4.2 | 5.3 | 3.7 | — | 8.7 |
| Dye, perfume, | 1.2 | 0.9 | 1.5 | 1.3 | 1.8 |
| minors | | | | | |

| | |
|---|---|
| NaOH | to pH 8.0 |
| Water | Balance |

### Example 5

The following are compositions in accord with the invention.

| | V | W | X | Y |
|---|---|---|---|---|
| Clay I and III or IV | 10.0 | 5.0 | 7.0 | 9.0 |
| LAS | — | 10.0 | 1.0 | 2.0 |
| C26AS | 14.0 | — | 1.0 | 2.0 |
| MBAS/TAS | 5.0 | 10.0 | 1.0 | 2.0 |
| Citric acid/sodium | 5.0 | 1.0 | 1.0 | 2.0 |
| citrate | | | | |
| Phosphate | 5.0 | 10.0 | — | — |
| Fatty acid | 5.0 | 10.0 | 110 | 15.0 |
| Hydrochiorid acid | 0.02 | 0.02 | 0.02 | 0.02 |
| Soil Release Polymer | — | — | 0.02 | 0.02 |
| borax | 2.0 | 1.0 | 0.6 | 0.6 |
| Perfume | 1 | 0.5 | 1 | 0.5 |
| enzymes | — | — | 1.5 | 2.0 |
| Dye | 10 ppm | 10 ppm | 50 ppm | 50 ppm |
| Pearlescence | 0.1 | 0.2 | 0.5 | 0.8 |

Water and minors to balance to 100%

What is claimed is:

1. A liquid detergent composition comprising at least 4.5% of a fabric softening clay and at least 8% by weight of a surfactant system comprising:
a) 80% to 100% of a salt of a sulfonate surfactant and/or a salt of a sulphate surfactant; and,
b) less then 10% by weight of alkoxylated anionic surfactants, alkoxylated amphoteric surfactants, alkoxylated zwitterionic surfactants and/or alkoxylated non-ionic surfactant.

2. A liquid detergent composition according to claim 1 wherein said surfactant system further comprises up to 20% of a surfactant selected from the group consisting essentially of cationic surfactant, zwitterionic surfactant, amphoteric surfactant, and combinations thereof.

2. A liquid detergent composition according to claim 1 being free of alkoxylated anionic surfactant.

3. A liquid detergent composition according to claim 1 further comprising up to 1.5% by weight of the composition and up to 10% by weight of the surfactant system of alkoxylated non-ionic surfactant having an average alkoxylation degree of 6 or below.

4. A liquid detergent composition according to claim 1 that is free of any alkoxylated anionic, amphoteric, zwitterionic, or non-ionic surfactants.

5. A liquid detergent composition according to claim 1 comprising at least 6.5% by weight of a fabric softening clay.

6. A liquid detergent composition according to claim 1 comprising at least 7% by weight of a fabric softening clay.

7. A liquid detergent composition according to claim 1 wherein said fabric softening clay is selected from the group consisting essentially of hectorite clay, montmorillonite clay, organophlic modified clay, and combinations thereof.

8. A liquid composition according to claim 1 comprising at least 15% by weight of said surfactant system.

9. A liquid composition according to claim 1 comprising at least 18% by weight of said surfactant system.

10. A liquid composition according to claim 1 whereby said anionic sulphate surfactant comprises a sodium salt of branched C₁₂-C₁₈ such that the weight average branching degree of the sulphate surfactant as a whole is at least 60%.

11. A liquid composition according to claim 10 whereby said anionic sulphate surfactant comprises a sodium salt of branched C₁₂-C₁₃ alkyl sulphate.

12. A liquid composition according to claim 1 whereby the anionic sulphate surfactant comprises a sodium salt of branched C₁₂-C₁₈ alkyl sulphate, such that the weight average branching degree of the sulphate surfactant as a whole is at least 80%.

13. A liquid composition according to claim 12 whereby the anionic sulphate surfactant comprises a sodium salt of branched C₁₂-C₁₃ alkyl sulphate.

14. A liquid composition according to claim 1 whereby the anionic surfactant consists of branched C₁₂-C₁₈ alkyl sulphate surfactant having a weight average branching degree of at least 60% of such a sulphate surfactant and a linear alkyl sulfonate surfactant.

15. A liquid composition according to claim 14 whereby the anionic surfactant has a weight average branching degree of at least 80% of such a sulphate surfactant and a linear alkyl sulfonate surfactant.

16. A liquid composition according to claim 14 whereby the anionic surfactant consists of branched C₁₂-C₁₃ alkyl sulphate surfactant having a weight average branching degree of at least 60% of such a sulphate surfactant and a linear alkyl sulfonate surfactant.

17. A liquid composition according to claim 1 comprising less than 50% by weight of a solvent.

18. A liquid composition according to claim 17 comprising less than 40% by weight of said solvent.

19. A liquid composition according to claim 17 wherein said solvent comprises water.

20. A liquid composition according to claim 1 comprising an aesthetic enhancer selected from the group consisting essentially of colorant dye, pearlescence agent, and combinations thereof.
